(19) United States
(12) Patent Application Publication
(10) Pub. No.: US 2017/0314475 A1
(43) Pub. Date: Nov. 2, 2017

(54) Remote pneumatic aneroid fuel controller devices and methods

(71) Applicant: Power Driven Diesel, LLC, Cedar City, UT (US)

(72) Inventors: William Joseph Terry, Cedar City, UT (US); Todd Alan Welch, Cedar City, UT (US)

(21) Appl. No.: 15/330,957

(22) Filed: Jul. 18, 2016

Related U.S. Application Data
(60) Provisional application No. 62/193,702, filed on Jul. 17, 2015.

(51) Int. Cl. F02D 1/14; F02D 11/08; F02B 39/16

(52) U.S. Cl. CPC F02D 1/14; F02B 39/16; F02D 11/08

(57) ABSTRACT

Devices and methods are described for remotely tuning a diesel engine of a vehicle using a pneumatic control device. A tunable control system for an aneroid fuel control (AFC) injection system includes a pneumatic control device that has a pneumatic pressure regulator configured to be adjusted by a first tuning adjustment controller and a pneumatic flow control valve configured to be adjusted by a second tuning adjustment controller. An air signal line links the pressure regulator to the flow control valve. The control system also includes an inlet line connected to the control device and configured to be connected to an air pressure source of an engine. An outlet line is connected to the control device and is configured to be connected to an AFC of an engine.

### CROSS REFERENCE TO RELATED APPLICATIONS

This application claims the benefit of priority from U.S. Provisional Application No. 62/193,702, filed 17 Jul. 2015, and entitled “In-Cab AFC Controller,” the disclosure of which is incorporated, in its entirety, by this reference.

### TECHNICAL FIELD

The present disclosure generally relates to devices and methods for controlling the tuning of an engine and more specifically relates to devices and methods for remotely controlling an aneroid fuel control (AFC) system of an engine.

### BACKGROUND

Commercially-available diesel trucks are popular among truck consumers for many reasons, including, for example, their ability to be tuned and optimized for different tasks. For example, DODGE® RAM® trucks that were sold from model years 1989 through 1998 are equipped with a CUMMINS® TURBO DIESEL engine that can be tuned for extra power or torque depending on the preferences of the driver. Other similar models include p-pumped 24 v CUMMINS engines or vehicles with a transplanted diesel engine that uses an injection pump with an aneroid fuel control (AFC).

More modern models of the RAM® and similar vehicles have computer-controlled tuning that can be customized in real-time using a controller in the cab, but the fuel injection systems in older vehicles cannot be remotely and electronically tuned or adjusted. Instead, a driver must manually access and adjust the mechanical diesel injection systems and AFC controller in order to change the tuning settings. This process is technical and requires intimate knowledge of how the tuning is to be performed in order to achieve a desired result. The user must physically access specific parts of the engine under the hood while the engine is not running. The manual tuning process is also prone to failure or dissatisfying results, such as under-tuning with sluggish engine performance or over-tuning with fuel wastage and embarrassing black exhaust. Often, the user is unable to tell whether the engine is over-tuned or under-tuned until he or she actually drives the vehicle, so if another adjustment needs to be made, the vehicle must stop, cool off, and then be mechanically adjusted again. This can be time-consuming, slow, and frustrating for the user, leading to the user driving a vehicle without his or her preferred tuning.

Accordingly, there is a need for improvements to methods of altering the settings of mechanical diesel injection pumps such as diesel AFC controllers.

### SUMMARY

One aspect of the present disclosure relates to a tunable control system for an aneroid fuel controlled injection system. The tunable control system may comprise a pneumatic control device comprising: a pneumatic pressure regulator configured to be adjusted by a first tuning adjustment controller, a pneumatic flow control valve configured to be adjusted by a second tuning adjustment controller, and an air signal line linking the pneumatic pressure regulator to the pneumatic flow control valve. The system may also include an inlet line connected to the pneumatic control device and configured to be connected to an air pressure source of an engine and an outlet line connected to the pneumatic control device and configured to be connected to an aneroid fuel controller (AFC).

The tunable control system may have the pneumatic pressure regulator configured to adjust total air pressure in the outlet line and may have the pneumatic flow control valve configured to adjust volume of the air pressure through the pneumatic flow control valve to the outlet line. The pneumatic control device may be positioned in a passenger compartment of a vehicle. The pneumatic control device may also be positioned in a vehicle and the first and second tuning adjustment controllers may be operable while the vehicle is in motion. The inlet line may be directly connected to the pneumatic pressure regulator. The inlet line may also be directly connected to the pneumatic flow control valve. In some embodiments, the system may further comprise the AFC. The pneumatic control device may be connected to a vehicle, and adjusting the first tuning adjustment controller and second tuning adjustment controller may alter a fuel delivery quantity produced by an injection pump of the vehicle. In some arrangements the system may comprise a bypass switch configured to allow air pressure from the inlet line to bypass the pneumatic control device and exit the outlet line. The air pressure source may be a turbocharger.

Another aspect of the disclosure relates to a method of controlling tuning of an engine having an aneroid fuel control (AFC) fuel injection system. The method may comprise providing a vehicle having an engine, a passenger compartment, and a pneumatic control device positioned in the passenger compartment, with the engine having an aneroid fuel control (AFC) with an air fitting and with the pneumatic control device comprising a pneumatic pressure regulator and a pneumatic flow control valve. The method may also include controlling flow of pressurized air to the pneumatic control device, converting the pressurized air to an air signal by passing the air through the pneumatic pressure regulator and the pneumatic flow control valve, and controlling flow of the air signal from the pneumatic control device to the aneroid fuel control with the air fitting, thereby adjusting a tuning setting of the engine.

In some configurations the method may further comprise adjusting the pneumatic pressure regulator or the pneumatic flow control valve using a tuning adjustment controller within the passenger compartment. The pneumatic pressure regulator or the pneumatic flow control valve may be adjusted while the engine is running. In some cases, the method may also include adjusting the pneumatic pressure regulator or the pneumatic flow control valve while the vehicle is in motion.

Yet another aspect of the disclosure relates to a vehicle having a tunable pneumatic fuel injection control system for a diesel engine. The vehicle may comprise an engine positioned on the vehicle, with the engine having an air intake plenum, a boost system connected to the air intake plenum of the engine, an aneroid fuel control (AFC) controller connected to a throttle of the engine, with the AFC comprising an adjustable air fitting, and a passenger compartment positioned on the vehicle. The vehicle may also comprise a pneumatic control device positioned in the passenger compartment, wherein the pneumatic control device may have a pneumatic pressure regulator and a pneumatic flow control valve, with the pneumatic pressure regulator and the pneumatic flow control valve being flowably connected to each other, with the pneumatic pressure regulator regulating a total air pressure output by the pneumatic control device, and with the pneumatic flow control valve controlling a volume of total air exiting the pneumatic control device. A first tube may connect air flow from the turbo system to the pneumatic control device in the passenger compartment, and a second tube may connect air flow from the pneumatic control device to the air fitting.

The above summary of the present invention is not intended to describe each embodiment or every implementation of the present invention. The Figures and the detailed description that follow more particularly exemplify one or more preferred embodiments.

### BRIEF DESCRIPTION OF THE DRAWINGS

The accompanying drawings and figures illustrate a number of exemplary embodiments and are part of the specification. Together with the present description, these drawings demonstrate and explain various principles of this disclosure. A further understanding of the nature and advantages of the present invention may be realized by reference to the following drawings. In the appended figures, similar components or features may have the same reference label.

FIG. 1 is a schematic diagram of a tuning control system according to the present disclosure.

FIG. 2 is a schematic diagram of another tuning control system according to the present disclosure.

FIG. 3 shows a pneumatic tuning control device according to another embodiment of the present disclosure.

FIG. 4 shows the pneumatic tuning control device of FIG. 3 and a version of the pneumatic tuning control device that has its housing removed.

FIG. 5 is a schematic diagram of another tuning control system according to the present disclosure.

While the embodiments described herein are susceptible to various modifications and alternative forms, specific embodiments have been shown by way of example in the drawings and will be described in detail herein. However, the exemplary embodiments described herein are not intended to be limited to the particular forms disclosed. Rather, the instant disclosure covers all modifications, equivalents, and alternatives falling within the scope of the appended claims.

### DETAILED DESCRIPTION

The present disclosure generally relates to devices and methods for controlling the tuning of an engine and more specifically relates to devices and methods for remotely controlling an aneroid fuel control (AFC) system of a turbocharged diesel engine. One aspect of the disclosure relates to a tunable control system for an AFC injection system, with the tunable control system comprising a pneumatic pressure regulator configured to be adjusted by a first tuning adjustment controller and a pneumatic flow control valve configured to be adjusted by a second tuning adjustment controller. An air signal line may link the pneumatic pressure regulator to the pneumatic flow control valve, an inlet line may connect to the pneumatic control device and may be configured to be connected to an air pressure source of an engine such as a turbocharger, and an outlet line may be connected to the pneumatic control device and may be configured to be connected to an aneroid fuel controller (AFC). The pneumatic pressure regulator may be configured to adjust total air pressure in the outlet line, and the pneumatic flow control valve may be configured to adjust volume of the air pressure through the pneumatic flow control valve to the outlet line. The pneumatic pressure regulator and the pneumatic flow control valve may be positioned in a passenger compartment of a vehicle so that the operator can dynamically change tuning settings for the engine on-the-fly, without having to stop the vehicle or make any mechanical adjustments to the engine.

Devices and methods disclosed herein may improve the control function of a factory AFC by providing live adjustment of the air signal used to control the AFC, ultimately allowing the user to alter mechanical fueling strategies of the mechanical diesel injection pump for differing driving and/or engine load conditions. In-cab, live, or on-the-fly adjustable tuning is not possible on mechanical diesel injection trucks equipped with an AFC injection pump such as model year 1989 through 1998 DODGE RAM trucks equipped with a CUMMINS TURBO DIESEL engine and comparable vehicles that lack computer AFC control. In-cab tuning is also not possible on p-pumped 24 v CUMMINS engines or vehicles with a transplanted diesel engine that uses an injection pump with an aneroid fuel control. Devices and methods of the present disclosure may therefore solve this and other problems by improving the convenience and accessibility of tuning control for a diesel engine.

As used herein, a regulator may be “adjusted” by controlling the pressure it outputs when provided with an air signal at its inlet. A flow control valve may be “adjusted” by controlling the rate of flow that comes from the outlet of the flow control valve when an air signal is provided to its inlet. A pneumatic pressure regulator is a device that receives an air supply and outputs a controlled maximum air pressure. A pneumatic flow control valve is a device that receives an air supply and controls the maximum rate of change of pressure output to an output tube.

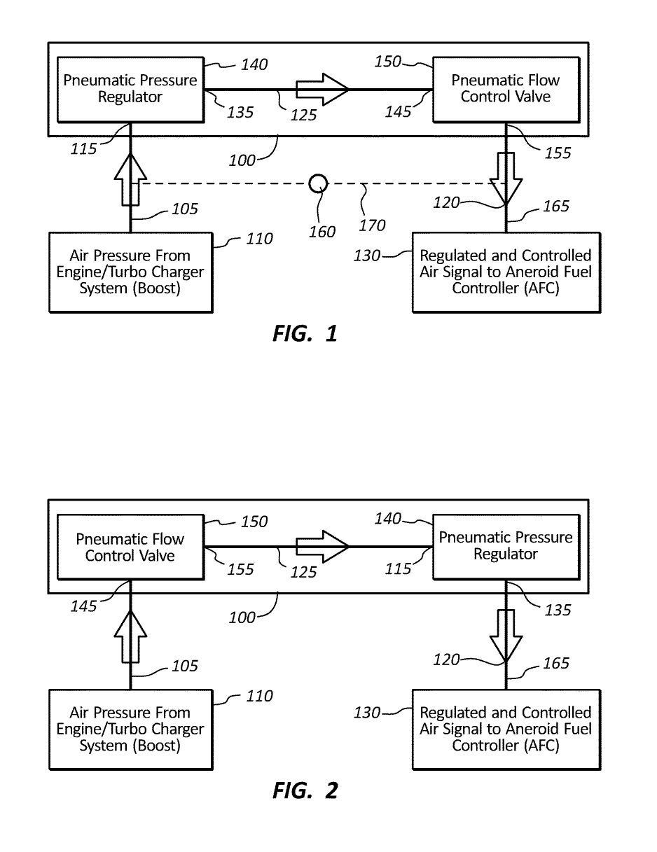

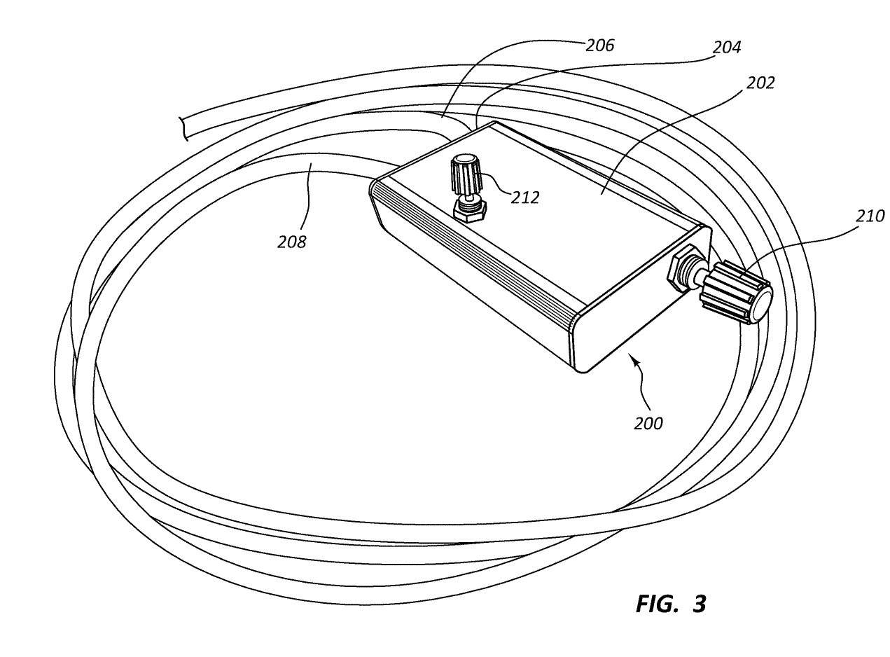

Now referring to FIGS. 1-2, in another example embodiment of the present disclosure, a pneumatic control device 100 connects to an air pressure source 110 (boost source) on the engine of a vehicle and then regulates and controls the pneumatic pressure signal 120 that flows into the aneroid fuel controller 130 on the injection pump. This device 100 may create a live, in-cab, on-the-fly tuning method for the aneroid fuel controller 130 via adjustments to a pressure regulator 140 and flow control valve 150 incorporated into the device 100. The device 100 may be remotely mounted inside a vehicle's passenger compartment, thereby providing a means for live, easily accessible tuning adjustments. Live or on-the-fly adjustments to the device 100 may regulate and control the pneumatic signal 120 (air pressure) which is plumbed into the aneroid fuel control 130 located in the engine compartment on the mechanical injection pump. Therefore, the device 100 may provide live, in-cab, on-the-fly tuning capability for mechanical diesel injection trucks equipped with an aneroid fuel controlled injection pump, such as model year 1989 through 1998 DODGE RAM trucks equipped with a CUMMINS TURBO DIESEL engine. Factory original equipment in those vehicles does not allow for live tuning, which may be a desirable function under various different driving and/or engine load conditions.

Embodiments of the present disclosure may also improve the control function of the factory aneroid fuel controller by providing live and/or on-the-fly adjustment capabilities to the air signal which ultimately allows the user to alter mechanical fueling strategies of the mechanical diesel injection pump for differing driving and/or engine load conditions.

Referring again to FIG. 1 in detail, air pressure may originate from an engine or turbo charger system (boost) 110. The point of origin may be at or near the air intake of the engine. The air supply may be under increased pressure relative to environmental/atmospheric air pressure due to operation of the turbocharger/boost system 110. The air supply may be provided from the turbocharger 110 to an inlet line 105 that is connected to the pneumatic control device 100. In the embodiment of FIG. 1, the inlet line 105 is connected to an inlet 115 of a pneumatic pressure regulator 140. The pneumatic pressure regulator 140 may regulate the pressure of the air supply that enters via the inlet line 105. For example, if the turbocharger provides an air supply at 40 psi, the pneumatic pressure regulator 140 may output an air supply to an air signal line 125 at a lower pressure, such as, for example, 5-10 psi.

Thus, regulated air exits the pneumatic pressure regulator 140 and flows into the pneumatic flow control valve 150 via the air signal line 125 that links an outlet 135 of the pneumatic pressure regulator 140 with an inlet 145 of the pneumatic flow control valve 150. The pneumatic flow control valve 150 controls the flow of air so that it exits the outlet 155 of the pneumatic flow control valve 150 at a predetermined rate of change of pressure over time. A regulated and controlled air signal 120 may therefore exit the pneumatic flow control valve 150 and flow into the aneroid fuel controller 130 via an outlet line 165. The aneroid fuel controller 130 may then use the regulated and controlled air signal 120 to alter the fuel delivery quantity produced by the factory injection pump. The AFC 130 may use the regulated and controlled air signal 120 even if the AFC 130 is a standard factory-installed mechanical AFC.

The pneumatic pressure regulator 140 may work independently to regulate total (i.e., maximum) air pressure in the pneumatic control system that is provided as the regulated and controlled air signal 120. The pneumatic flow control valve 150 may work together with the pneumatic pressure regulator 140 to control the volume of regulated air that flows to the aneroid fuel controller 130. The volume of total air that passes through the pneumatic flow control valve 150 is dependent on the regulated air pressure (i.e., the air pressure in the air signal line 125) and therefore the pneumatic pressure regulator 140 and pneumatic flow control valve 150 work together to create a uniquely tunable control system. By regulating and controlling the air pressure signal that enters a factory original aneroid fuel controller, the quantity of fuel produced by the mechanical diesel injection pump can be controlled live, in-cab, and while the vehicle is in motion.

In some embodiments, an air fitting may be plumbed into a pressurized airport on the engine's intake plenum. This air fitting may be part of the connection between the turbocharger 110 and the vehicle's engine. Tubing (e.g., inlet line 105) transports the pressurized air from the air fitting at the turbocharger 110 to a pneumatic pressure regulator 140 located inside the driver/passenger compartment of the vehicle. High pressure air may then be regulated down to a user-adjustable value by the pneumatic pressure regulator 140 and then exit the pneumatic pressure regulator 140 into the air signal line 125. Regulated air may then be transported from the pneumatic pressure regulator 140 through tubing (e.g., air signal line 125) into a pneumatic flow control valve 150 that may also be located in the driver/passenger compartment of the vehicle. The amount of regulated air signal is then controlled to a user-determined adjustable volume/displacement and then exits the pneumatic flow control valve 150 to the outlet line 165. The regulated and controlled air signal 120 is then transported through tubing (e.g., outlet line 165) back to the engine compartment and connected to the aneroid fuel control 130 with an air fitting.

The pneumatic pressure regulator 140 and pneumatic flow control valve 150 may both be necessary so that the user can control both the total pressure and the total volume of the air signal 120. Using just one of the pneumatic pressure regulator 140 or pneumatic flow control valve 150 may only provide partial beneficial control of the air signal.

In some embodiments, the mounting location of the device 100 may be different from the passenger compartment of the vehicle. For example, the device 100 may be located anywhere on the vehicle and still perform its intended functions as long as it remains accessible for tuning adjustments.

In some arrangements, a pressure gauge may be added to the regulated and controlled side of the device 100 (e.g., at the outlet line 165) to display air pressure values of the regulated and controlled air signal 120.

In some configurations, a pneumatic bypass switch 160 (see FIG. 1) may also be added to the device to allow for a bypass mode wherein direct air pressure from the engine boost source turbocharger 110 may flow directly into the AFC 130 to permit unmodified operation of the AFC 130. Accordingly, the pneumatic bypass switch 160 may turn on or off the flow of air through a bypass line 170 that links the air supply of the turbocharger 110 to the AFC 130.

FIG. 2 shows another embodiment of the present disclosure wherein the pneumatic control device 100 has an alternate configuration. In this embodiment, the positions of the pneumatic flow control valve 150 and the pneumatic pressure regulator 140 are exchanged. This alternative configuration permits the same operation as the embodiment shown in FIG. 1. Accordingly, the inlet line 105 may be connected to the inlet 145 of the pneumatic flow control valve 150, the air signal line 125 may be connected to the outlet 155 of the pneumatic flow control valve 150 and the inlet 115 of the pneumatic pressure regulator 140.

During heavy engine load conditions, the intake plenum of the engine can experience high air pressure at low engine RPM. A common heavy engine load condition could be encountered when a vehicle climbs a mountain grade. Under these conditions, the high pressure air signal at the intake can cause the factory-original AFC to command heavy fueling from the mechanical injection pump (i.e., over-fueling). Accordingly, this causes high exhaust gas temperatures and visible smoke emissions. In-cab AFC control devices of the present disclosure (e.g., device 100) may decrease the total pressure and decrease the total volume of air signal flowing to the AFC in the above heavy engine load condition. Accordingly, the user may dynamically reduce fuel injection quantity, lower the exhaust gas temperature, and reduce visible exhaust emissions (e.g., black smoke). When the user or driver sees visible emissions or high exhaust gas temperatures, he or she can adjust the pneumatic pressure regulator 140 and pneumatic flow control valve 150 with the vehicle in motion to adjust the air signal conveyed to the aneroid fuel controller 130 and ultimately change the commanded fuel injection quantity.

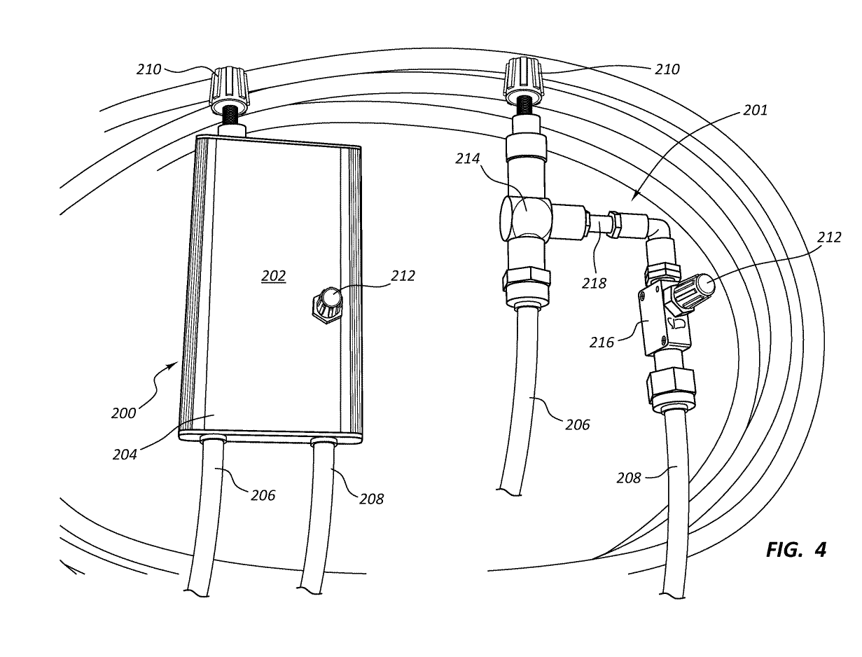

FIGS. 3-4 depict example embodiments of a pneumatic control device 200 of the present disclosure. The pneumatic control device 200 may comprise a housing 202 with an end 204 through which an inlet tube 206 and an outlet tube 208 extend. A first tuning adjustment controller 210 and a second tuning adjustment controller 212 are also positioned on the housing 202. FIG. 4 shows a pneumatic control device 200 having the housing 202 and a pneumatic control device 201 that has its housing 202 removed. With the housing 202 removed, the internal components of the device 201 are shown. The inlet tube 206 connects to a pneumatic pressure regulator 214, and the outlet tube 208 connects to a pneumatic flow control valve 216. The pneumatic pressure regulator 214 may be a pneumatic pressure regulator 140 of FIG. 1, and the pneumatic flow control valve 216 may be a pneumatic flow control valve 150 of FIG. 1. The pneumatic pressure regulator 214 and pneumatic flow control valve 216 may be connected to each other by an air signal line 218.

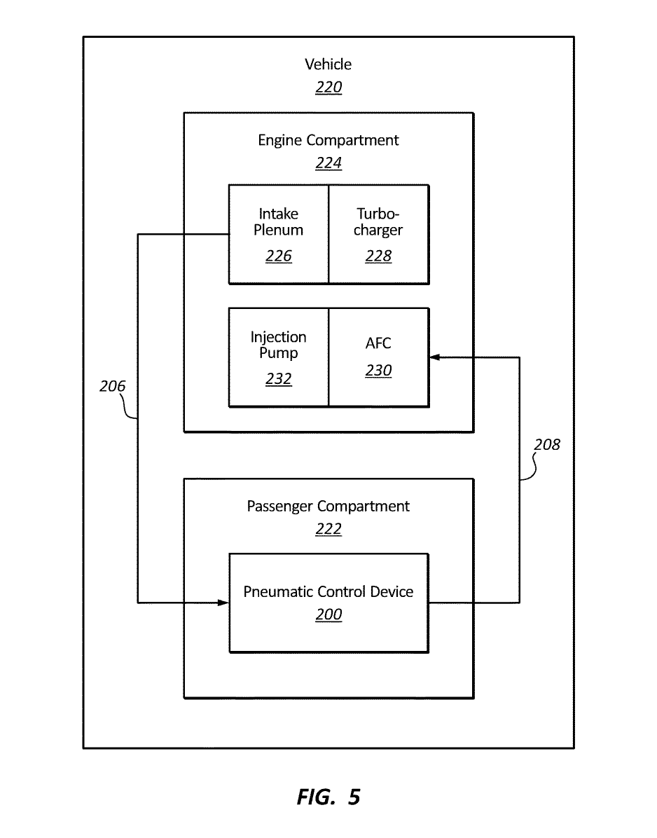

FIG. 5 shows a schematic version of a vehicle 220 on which the pneumatic control device 200 may be installed. Referring now to FIGS. 3-5, the housing 202 may be positioned in or may be accessible from within the passenger compartment 222 of the vehicle 220. In some embodiments, the housing 202 may be mounted to a dashboard or other portion of the console of a vehicle. For example, the housing 202 may be installed where the first and second tuning adjustment controllers 210, 212 are within reach of a driver of the vehicle while driving the vehicle. The inlet and outlet tubes 206, 208 may extend from the passenger compartment 222 into the engine (or into an engine compartment 224 that is separate from the passenger compartment 222 on the vehicle 220. Thus, the driver or user of the control device 200 may access and use the control device 200 when driving the vehicle 220.

The first and second tuning controllers 210, 212 may comprise knobs, switches, slides, buttons, pulls, and/or other control features on the housing 202. The tuning controllers 210, 212 may be finely controlled so that the user can precisely adjust the pressure and flow rate of the air signal that enters the outlet tube 208 to have desired settings. By having precise control, the user can dynamically tune the fuel-air ratio of the vehicle 220 to avoid high temperature and black exhaust (i.e., over-fueling) or sluggish performance (e.g., under-fueling). If the vehicle 220 is experiencing over- or under-fueling, the operator may quickly tune the air signal in the outlet tube 208 to correct the problem. For example, the user can avoid over-fueling during upward/mountain-grade climbs by reducing fuel injection during the climb and then resuming normal fuel injection upon reaching the top of a climb.

The inlet and outlet tubes 206, 208 may comprise plastic tubing or similar material used to hold air pressure. The tubing may have sufficient rating to support high pressures produced at the intake plenum 226 and turbocharger 228 of the vehicle 220 and in the inlet tube 206 and to prevent collapse of the tubing when the pressure is regulated down to a lower level in the outlet tube 208. At least the outlet tube 208 may also be configured to connect to an air fitting at the AFC 230 so that the AFC 230 can properly control the mechanical injection pump 232.

Another aspect of the present disclosure relates to methods of controlling the tuning of an engine having an aneroid fuel control (AFC) fuel injection system. One method may comprise providing a vehicle (e.g., vehicle 220), controlling flow of pressurized air to a pneumatic control device in the vehicle (e.g., pneumatic control device 200), converting the pressurized air to an air signal by passing the air through a pneumatic pressure regulator and a pneumatic flow control valve (e.g., regulator 140 and flow control valve 150), and controlling flow of the air signal from the pneumatic control device to an aneroid fuel control (AFC) of the engine of the vehicle (e.g., AFC 130 or 230) with its air fitting, thereby adjusting a tuning setting of the engine. The pressure regulator and flow control valve may be adjusted using a tuning adjustment controller within the passenger compartment of the vehicle (e.g., as shown in FIGS. 3-4). The method may also further comprise adjusting the pneumatic pressure regulator or the pneumatic flow control valve while the engine is running or while the vehicle is in motion.

The present description provides examples, and is not limiting of the scope, applicability, or configuration set forth in the claims. Thus, it will be understood that changes may be made in the function and arrangement of elements discussed without departing from the spirit and scope of the disclosure, and various embodiments may omit, substitute, or add other procedures or components as appropriate. For instance, the methods described may be performed in an order different from that described, and various steps may be added, omitted, or combined. Also, features described with respect to certain embodiments may be combined in other embodiments.

Various inventions have been described herein with reference to certain specific embodiments and examples. However, they will be recognized by those skilled in the art that many variations are possible without departing from the scope and spirit of the inventions disclosed herein, in that those inventions set forth in the claims below are intended to cover all variations and modifications of the inventions disclosed without departing from the spirit of the inventions. The terms “including:” and “having” come as used in the specification and claims shall have the same meaning as the term “comprising.”

1. A tunable control system for an aneroid fuel controlled injection system, the tunable control system comprising:
a pneumatic control device comprising:
a pneumatic pressure regulator configured to be adjusted by a first tuning adjustment controller;
a pneumatic flow control valve configured to be adjusted by a second tuning adjustment controller;
an air signal line linking the pneumatic pressure regulator to the pneumatic flow control valve;
an inlet line connected to the pneumatic control device and configured to be connected to an air pressure source of an engine;
an outlet line connected to the pneumatic control device and configured to be connected to an aneroid fuel controller (AFC).

2. The tunable control system of claim 1, wherein the pneumatic pressure regulator is configured to adjust total air pressure in the outlet line.

3. The tunable control system of claim 1, wherein the pneumatic flow control valve is configured to adjust volume of air pressure through the pneumatic flow control valve to the outlet line.

4. The tunable control system of claim 1, wherein the pneumatic control device is positioned in a passenger compartment of a vehicle.

5. The tunable control system of claim 1, wherein the pneumatic control device is positioned in a vehicle and the first and second tuning adjustment controllers are operable while the vehicle is in motion.

6. The tunable control system of claim 1, wherein the inlet line is directly connected to the pneumatic pressure regulator.

7. The tunable control system of claim 1, wherein the inlet line is directly connected to the pneumatic flow control valve.

8. The tunable control system of claim 1, further comprising the AFC.

9. The tunable control system of claim 1, wherein the pneumatic control device is connected to a vehicle and adjusting the first tuning adjustment controller and second tuning adjustment controller alters a fuel delivery quantity produced by an injection pump of the vehicle.

10. The tunable control system of claim 1, further comprising a bypass switch configured to allow air pressure from the inlet line to bypass the pneumatic control device and exit the outlet line.

11. The tunable control system of claim 1, wherein the air pressure source is a turbocharger.

12. A method of controlling tuning of an engine having an aneroid fuel control (AFC) fuel injection system, the method comprising:
providing a vehicle having an engine, a passenger compartment, and a pneumatic control device positioned in the passenger compartment, the engine having an aneroid fuel control (AFC) with an air fitting, the pneumatic control device comprising a pneumatic pressure regulator and a pneumatic flow control valve;
controlling flow of pressurized air to the pneumatic control device;
converting the pressurized air to an air signal by passing the air through the pneumatic pressure regulator and the pneumatic flow control valve;
controlling flow of the air signal from the pneumatic control device to the aneroid fuel control with the air fitting, thereby adjusting a tuning setting of the engine.

13. The method of claim 12, further comprising adjusting the pneumatic pressure regulator or the pneumatic flow control valve using a tuning adjustment controller within the passenger compartment.

14. The method of claim 12, further comprising adjusting the pneumatic pressure regulator or the pneumatic flow control valve while the engine is running.

15. The method of claim 12, further comprising adjusting the pneumatic pressure regulator or the pneumatic flow control valve while the vehicle is in motion.

16. A vehicle having a tunable pneumatic fuel injection control system for a diesel engine, the vehicle comprising:
an engine positioned on the vehicle, the engine having an air intake plenum;
a boost system connected to the air intake plenum of the engine;
an aneroid fuel control (AFC) controller connected to a throttle of the engine, the AFC comprising an adjustable air fitting;
a passenger compartment positioned on the vehicle;
a pneumatic control device positioned in the passenger compartment, the pneumatic control device having a pneumatic pressure regulator and a pneumatic flow control valve, the pneumatic pressure regulator and the pneumatic flow control valve being flowably connected to each other, the pneumatic pressure regulator regulating a total air pressure output by the pneumatic control device, the pneumatic flow control valve controlling a volume of total air exiting the pneumatic control device;
a first tube connecting air flow from the turbo system to the pneumatic control device in the passenger compartment;
a second tube connecting air flow from the pneumatic control device to the air fitting.
